(19) United States
(12) Patent Application Publication
(10) Pub. No.: US 2007/0109785 A1
(43) Pub. Date: May 17, 2007

(54) System and method for proactively controlling interior light in vehicles

(76) Inventors: Marten Wittorf, Ingelheim (DE); Lars Hoffmann, Bralanda (SE)

Correspondence Address: HARNESS, DICKEY & PIERCE, P.L.C., P.O. BOX 8910, RESTON, VA, 20195, US

(21) Appl. No.: 11/515,993

(22) Filed: Sep. 6, 2006

(30) Foreign Application Priority Data
Sep. 6, 2005 (SE) 0501964-1

(51) Int. Cl. F21V 23/04

(52) U.S. Cl. 362/276; 362/488

(57) ABSTRACT

The present invention relates to a system and a method for interior light. More specifically, the invention concerns a system and a method for proactively controlling interior light in vehicles. The system according to the present invention comprises at least one light source, at least one data retrieval unit which is adapted to retrieve data on at least one object located in said vehicle or in the immediate surroundings of the vehicle, and at least one processing unit which is adapted to analyze said retrieved data. Said processing unit is also adapted to proactively control light patterns inside the vehicle based on said analyzed data. Advantages achieved by the invention imply that the amount of light in the vehicle can be minimized while at the same time traffic safety can be increased by individuals in the vehicle not having to keep track of more than a necessary and relevant amount of light-related information, and they may concentrate on the driving of the vehicle instead. Moreover, the present invention adds to the sense of response and interaction between man and vehicle being increased.

### PRIORITY STATEMENT

This application claims benefit of priority under 35 U.S.C. § 119 from Swedish Patent Application No. 0501964-1 filed on Sep. 6, 2005, in the Swedish Patent Office, the disclosure of which is incorporated herein by reference in its entirety.

1. Field of the Invention

The present invention relates to a system for interior light. More specifically, the present invention relates to a system for proactively controlling interior light in vehicles. The present invention also concerns a corresponding method for proactively controlling interior light in vehicles.

2. Background Art

Systems for light inside vehicles (for instance cars), such as in the passenger compartment and in various storage compartments, are frequently used.

Prior art interior light systems for vehicles concern in general different types of ordinary lighting appliances, which normally, by the action of sensors, are only activated by opening a door and deactivated when closing the door.

This gives, for instance, the drawback that the passenger compartment is dark for most of the time the car is in use. If a person in the vehicle has to look for something or read a map, he must manually activate the interior light. The darkness of the compartment thus is a potential danger and may also be experienced as unpleasant.

Similarly, light in the glove compartment of a vehicle is only activated when the lid of this compartment is being opened.

In other words, such prior art systems do not comprise any specific control of the light, given parameters such as presence/absence, size or movement of an individual in the vehicle.

US20030142504, “Interior lighting system of a motor vehicle and a method for controlling the same”, discloses a system by which a basic light is constantly activated as long as an individual is located in the car. The light in the vehicle is automatically variable as a function of operating and ambient parameters, such as ambient temperature or speed of the car. The device can also be operated manually.

In addition various solutions are known, which are aimed at detecting the presence/absence of a person or another object in a car, for the purpose of using the obtained information to control different parameters.

US20020140215, “Vehicle object detection system and method”, relates to a method and device for obtaining information about an object or a part in a car. The information is used to control a component in a car based on the characteristics of the object in question. The object can be an individual in a car and information on the object (size, position). The device is suited to control parameters for an airbag or a hi-fi system.

However, it is not the purpose of the above mentioned device to be used for controlling the interior light, and nor is it in any way obvious from the documentation how this could be done.

It will thus be appreciated that there is a need for an improved system and method for controlling interior light in a vehicle.

### SUMMARY OF THE INVENTION

Prior art systems cannot proactively initiate adjusted light patterns inside the car, for example given that detected or predicted by sensors and logics concerning what an individual positioned in the car intends to do, which may cause a particular light in a certain area in the vehicle.

The overall object of the present invention is to provide a system and a method to at least partially alleviate this problem.

This and other objects of the present invention are achieved by a system and a method according to claims 1 and 10. Preferred embodiments are defined in the dependent claims.

A first aspect of the invention concerns a system for controlling interior light in a vehicle, comprising at least one light source, at least one data retrieval unit which is adapted to retrieve data on at least one object located in said vehicle, and at least one processing unit which is adapted to analyze said retrieved data. The system is characterized in that said processing unit is also adapted to proactively control a light pattern inside the vehicle based on said analyzed data.

The present invention thus suggests a smart system for interior light, which by means of at least one data retrieval unit, such as a sensor or the like, detects where an object in the vehicle is positioned, such as an individual in a passenger car, or what he intends to do next, and uses the information obtained to automatically initiate and control, by a processing unit, a light pattern which is specially adjusted to the intentions of the object or the individual in the car.

This gives, for instance, the advantage that if the individual intends to open a storage compartment and therefore moves towards this compartment, the light in the area adjacent to this compartment is automatically switched on, without the individual having to activate the general interior light manually to be able to see properly and be correctly guided.

This also gives the advantage that the amount of light in a vehicle can be minimized, for instance light for dashboard and controls, thus making it possible to realize saving of power and an increased life of the components included (light sources etc) while at the same time traffic safety can be maintained and even improved, by the driver and other people in the vehicle not having to keep track of more than a necessary and continuously updated and relevant amount of light-related information, but instead they can concentrate on the driving of the vehicle.

That the system according to the present invention also adds to increase the sense of response and interaction between man and vehicle is a further advantage.

One example where the system according to the present invention may be used is that it registers faults, disturbances or “abnormal” settings of different kinds while travelling in the vehicle. If, for example, the entertainment and communication package of the vehicle, while travelling, registers a damage.to a CD which is being played, the system is adapted to assume that an individual in the vehicle will have to take adjusting measures in connection with the CD and radio unit of the vehicle, in which case the system initiates a light specially adjusted to the purpose. In practice this means that controls in connection with the CD and radio unit of the vehicle are illuminated more distinctly compared with other controls, thus allowing individuals in the vehicle to find the correct control without jeopardizing traffic safety.

Another example is that the system automatically initiates a light in connection with the storage compartments of the vehicle, in particular in connection with the cup holder of the vehicle if the at least one data retrieval unit registers that the vehicle is driven at a very low speed while at the same time the side window is lowered and the driver leans out of the car. The system thus assumes that in such a case the vehicle is located at a drive-in counter window, such as in fast food restaurants. In this case, the sense of response and interaction between man and vehicle is increased.

In one embodiment of the system according to the present invention, this system comprises at least one unit for retrieving data on the immediate surroundings of the vehicle.

Furthermore said unit for retrieving data on the immediate surroundings of the vehicle may comprise at least one of a camera, a radar and a unit for retrieving position based navigation information.

Such a unit for retrieving position based navigation information can be, for example, a GPS device or the like, or a crash sensor, reverse sensor, sensors for the dead angle, distance sensors or the like.

The invention thus concerns also a system which automatically can control different light patterns given not only what objects or individuals in the vehicle undertake or may undertake, but the system also comprises that the light is controlled given ambient parameters.

An example of this is that certain light patterns are automatically initiated if the vehicle approaches a tunnel or some other phenomenon in the surroundings which may cause a special light in the vehicle, for instance in the form of a light being activated in connection with controls in the vehicle which are involved in the special context.

Another example of advantageous use of the system is that, in self diagnosis while travelling, the vehicle detects a serious defect in the actual vehicle or discovers an approaching, potentially dangerous traffic situation. In such cases, the system according to the invention is adapted to assume that the driver is under great stress due to the gravity of the situation and the system can appropriately automatically initiate and control a light in connection with, for example, the warning signal button on the dashboard of the vehicle or a first aid kit in the trunk of the vehicle.

A further example of a situation where the invention would be applicable is the following. A driver is travelling in his vehicle but has to get out and fetch something from the trunk. It is dark outside. While he gets out of the vehicle and moves towards the trunk, the following happens. The system assumes that the driver is going to open the trunk lid and therefore automatically and proactively switches on the light adjacent to the handle of the trunk lid and in the trunk of the car. The tail lights and any light adjacent to the running board of the vehicle are kept switched on in order to make it easy for the driver to move without stumbling or stepping into puddles, dirt or the like. In this case, the sense of response and interaction between man and vehicle are increased and the driver is also made more visible to other road users, which is advantageous from the viewpoint of traffic safety.

In one embodiment of the system according to the present invention, said analysed data concerns at least one of data on presence, size and movement of said at least one object.

In one embodiment of the system according to the present invention, said at least object is an individual.

In one embodiment of the system according to the present invention, said processing unit comprises adaptive logics, in which case said light patterns can be proactively controlled according to specially adjusted patterns.

This means that the system comprises a self-teaching function, since it is adapted to sense repeated occurrences and behaviours over time and, based on such information, automatically initiate and control specially adjusted light patterns in the vehicle.

For instance, the driver may be in the habit of using the air conditioning system in a certain way each time he begins using the vehicle, first full power and then switched off. The at least one processing unit senses this pattern and the system. continuously learns to switch on the light in the area adjacent to the air conditioning controls according to a given time schedule.

Another example may be that the driver is in the habit of downloading MP3 files to the entertainment. system of the vehicle at certain given points of time, in which case the system learns this and proactively activates a light adjacent to the MP3 interface at said given points of time.

In another situation, when driving, the driver has made some “unusual” settings, such as opening the glove compartment without closing it again or switching off the radio system, which settings have not being corrected. The system is adapted to assume that the driver, when returning to the vehicle, wants to reset these unusual settings, and is therefore adapted to illuminate the areas where the unusual settings have been done for a certain time, once the driver gets into the vehicle again.

In one embodiment of the system according to the present invention, said processing unit comprises the ECU, electronic control unit, of the vehicle.

In one embodiment of the system according to the invention, the system comprises means for speech control.

Thus, the system according to the invention is, as stated above, adapted to be connected to the entertainment and communication package of the vehicle. For example, the system allows that a light in the glove compartment and/or on the floor of the vehicle is activated at a command prompt of the type “I'm looking for. . . ”. Other command prompts could be “dim out”, in which case the system automatically turns off all non-essential lights in the vehicle.

In one embodiment of the system according to the present invention, the system comprises different activity levels.

This means that the system is adapted to be used to different extents, as required. Sometimes the individuals in the vehicle want the system to be completely switched off, while in other cases they want a light to be automatically initiated in some cases, but not in others. In other words the system is adapted to let individuals in the vehicle select the degree of connection of the system and the degree of interior light automatic functions.

A second aspect of the invention concerns a method for controlling interior light in a vehicle, comprising the steps of retrieving data on at least one object located in said vehicle, analyzing said retrieved data, and proactively controlling light patterns inside the vehicle based on said analyzed data.

In one embodiment of the method according to the invention, it further comprises the step of retrieving data on the immediate surroundings of the vehicle.

In one embodiment of the method according to the invention, said steps of retrieving data and analyzing data concern at least one of data on presence, size and movement of said at least one object.

In one embodiment of the method according to the present invention, said light patterns can be proactively controlled according to special adjusted patterns.

In one embodiment of the method according to the invention, it comprises speech control.

In one embodiment of the method according to the invention, it comprises different activity levels.

An explanation of and advantages of the method for controlling interior light in a vehicle and various embodiments of the same correspond to the explanations and advantages that have been stated in relation to the system for controlling interior light in a vehicle.

### BRIEF DESCRIPTION OF THE DRAWINGS

The present invention will in the following be described in more detail with reference to the accompanying drawings which by way of example illustrate currently preferred embodiments of the invention.

FIG. 1 is a flow chart of a method for controlling interior light in a vehicle according to a preferred embodiment of the invention.

FIG. 2 illustrates schematically light patterns which can be controlled by a system for controlling interior light in a vehicle according to a preferred embodiment of the invention.

FIG. 3 illustrates schematically a system for controlling interior light in a vehicle according to a preferred embodiment of the invention.

### DETAILED DESCRIPTION OF PREFERRED EMBODIMENTS

The following description concerns a system and a method according to the present invention.

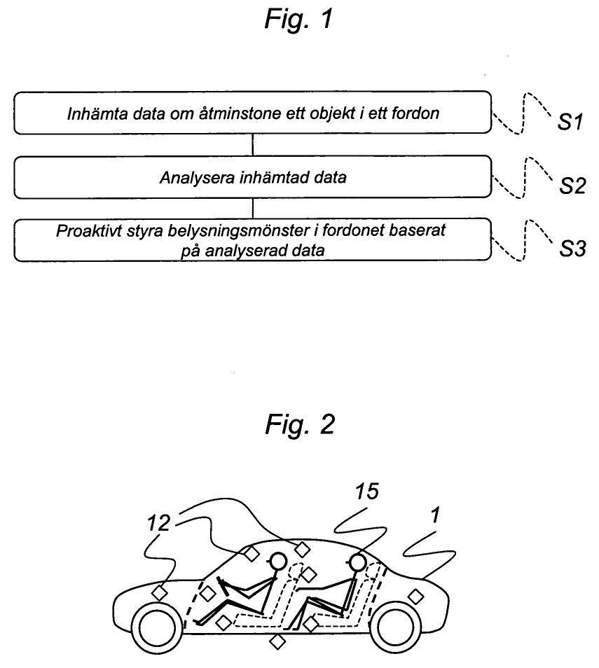

FIG. 1 is a flow chart of a method for controlling interior light in a vehicle. The flow chart shows the steps S1-S3, which are performed according to a preferred embodiment of the invention.

In step S1, data on at least one object, such as an individual 15, which is located in said vehicle, is retrieved. This occurs by means of a data retrieval unit 13. Such a data retrieval init 13 can be, for example, a camera (for instance a thermal, CMOS and/or CCD camera), radar equipment and/or a unit for retrieving position based navigation information, such as a GPS unit. Another suitable type of a data retrieval unit 13 can be a capacitive sensor.

The different conceivable types of camera are suited to retrieve different kinds of information; for instance a thermal camera is suited to retrieve position and temperature information on an individual or an animal which moves adjacent to the roadway. Radar equipment advantageously functions to assess, for instance, a distance to an adjacent object. In a specially preferred embodiment, a camera and/or radar information are combined with position based navigation information. Position based navigation information preferably consists of global positioning data (GPS) in combination with detailed information on roads and current traffic information.

The retrieved data may involve presence, size and/or movement of said object 15 in the vehicle.

In step S2, said retrieved data is analyzed. The analysis is performed by a processing unit 14. The ECU, electronic control unit, of the vehicle is an example of such a processing unit, but any type of processing unit with a corresponding functionality is conceivable.

In step S3, light patterns inside the vehicle are initiated and controlled proactively, based on said analyzed data. Controlling is performed by the processing unit 14 and is executed by light sources 12 being switched on and off in different light patterns and to different extents.

The above summary of the invention states a number of examples of situations where the present invention may be used and where the processing unit 14 analyzes retrieved data and proactively initiates and controls adjusted light patterns, based on the retrieved data on objects 15 in the vehicle and data on the immediate surroundings of the vehicle. The step of retrieving data on the immediate surroundings of the vehicle, however, is not shown in the flow chart in FIG. 1.

FIG. 2 illustrates schematically an example of a light pattern, indicated by light sources 12, which are controlled by a preferred embodiment of the system for controlling interior light in a vehicle 1 according to the invention.

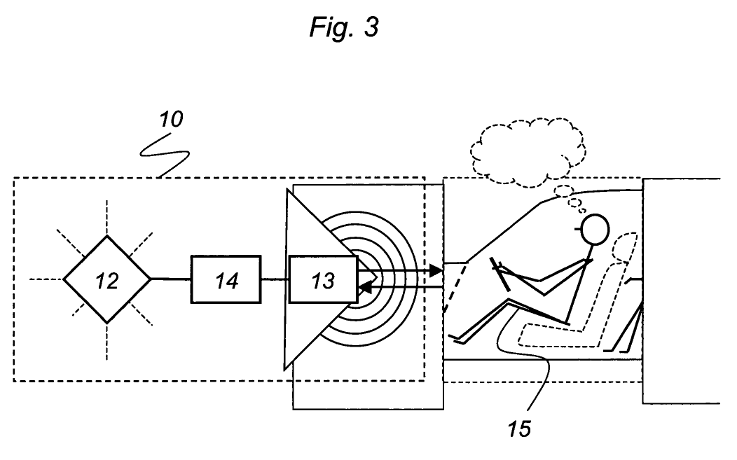

FIG. 3 illustrates schematically such a system 10 for controlling interior light in a vehicle 1 according to a preferred embodiment of the invention. The system in FIG. 3 comprises at least one light source 12, one data retrieval unit 13 which is adapted to retrieve data on at least one object 15 which is located in said vehicle 1, and at least one processing unit 14 which is adapted to analyze said retrieved data. Said processing unit 15 proactively controls light patterns inside the vehicle 1 based on said analyzed data. Such a light pattern is schematically illustrated in FIG. 2.

It will easily be appreciated that many modifications of the above described embodiments are conceivable within the scope of the invention. For example, the vehicle in question, which is generally associated with a passenger car, can just as well be replaced by a truck or some other vehicle, such as busses, motor cycles etc.

What we claim and desire to secure by Letters Patent: is:

1. A system for controlling interior light in a vehicle, comprising
at least one light source,
at least one data retrieval unit which is adapted to retrieve data on at least one object located in said vehicle,
and at least one processing unit which is adapted to analyze said retrieved data,
wherein
said processing unit is also adapted to proactively control light patterns inside the vehicle based on said analyzed data.

2. A system as claimed in claim 1, which further comprises at least one unit for retrieving data on the immediate surroundings of the vehicle.

3. A system as claimed in claim 2, in which said unit for retrieving data on the immediate surroundings of the vehicle comprises at least one of a camera, a radar and a unit for retrieving position based navigation information.

4. A system as claimed in claim 1, in which said analyzed data concerns at least one of data on presence, size and movement of said at least one object.

5. A system as claimed in claim 1, in which said at least one object is an individual.

6. A system as claimed in claim 1, wherein said processing unit further comprises adapted logics, said light patterns being proactively controllable according to special adjusted patterns.

7. A system as claimed in claim 1, in which said processing unit comprises the ECU of the vehicle.

8. A system as claimed in claim 1, which system comprises means for speech control.

9. A system as claimed in claim 1, which system comprises different activity levels.

10. A method for controlling interior light in a vehicle, comprising the steps of
retrieving data on at least one object located in said vehicle,
analyzing said retrieved data,
proactively controlling light patterns inside the vehicle based on said analyzed data.

11. A method as claimed in claim 10, which further comprises the step of retrieving data on the immediate surroundings of the vehicle.

12. A method as claimed in claim 10, in which said steps of retrieving data and analyzing data concern at least one of data on presence, size and movement of said at least one object.

13. A method as claimed in claim 10, wherein said light patterns are proactively controllable according to special adjusted patterns.

14. A method as claimed in claim 10, which method comprises speech control.

15. A method as claimed in claim 10, which methods comprises different activity levels.
